(19) United States
(12) Patent Application Publication
(10) Pub. No.: US 2023/0121563 A1
(43) Pub. Date: Apr. 20, 2023

(54) GAS SUPPLY AMOUNT MEASUREMENT METHOD AND GAS SUPPLY AMOUNT CONTROL METHOD

(71) Applicant: FUJIKIN INCORPORATED, Osaka (JP)

(72) Inventors: Takatoshi NAKATANI, Osaka-shi (JP); Atsushi HIDAKA, Osaka-shi (JP); Masaaki NAGASE, Osaka-shi (JP); Kouji NISHINO, Osaka-shi (JP); Nobukazu IKEDA, Osaka-shi (JP)

(73) Assignee: FUJIKIN INCORPORATED, Osaka (JP)

(21) Appl. No.: 17/906,064

(22) PCT Filed: Mar. 18, 2021
(86) PCT No.: PCT/JP2021/011117

§ 371 Date: Sep. 9, 2022

(30) Foreign Application Priority Data
Mar. 30, 2020 (JP) 2020-060171

(51) Int. Cl. G01F 22/02; G05D 7/06; G05B 19/416

(52) U.S. Cl. CPC G01F 22/02; G05D 7/0623; G05D 7/0635; G05B 19/416; G05B 2219/41108

(57) ABSTRACT

A gas supply amount measurement method is performed in a gas supply system including a vaporization section, a control valve provided downstream of the vaporization section, and a supply pressure sensor for measuring the supply pressure between the vaporization section and the control valve. The method comprises: a step of measuring an initial supply pressure by the supply pressure sensor in a state where the control valve is closed; a step of opening the control valve for only a predetermined time; a step of measuring for a plurality of times of the supply pressure in a period of time between a time at which the pressure starts to fall from the initial supply pressure and a time at which a predetermined time has elapsed when the control valve is open for only a predetermined time, and a step of determining the gas supply amount when the control valve is open for only a predetermined time by calculation based on the measured values of the plurality of supply pressures.

### TECHNICAL FIELD

The present invention relates to a gas supply amount measurement method and a gas supply amount control method, and more particularly, to a gas supply amount measurement method for measuring a supply amount of a gas generated in a vaporization section and supplied in a pulsed manner and a gas supply amount control method using the same.

### BACKGROUND OF INVENTION

In semiconductor manufacturing equipment, or a chemical plant, etc., various process gas, such as a raw material gas or an etching gas, is supplied to a process chamber. As a device for controlling a flow rate of the supplied gas, a mass flow controller (thermal mass flow controller) or a pressure type flow rate control device is known.

The pressure type flow rate control device can control the mass flow rate of various fluids with high accuracy by a relatively simple configuration, that is a combination of a control valve and a restriction part (e.g., an orifice plate or a critical nozzle) provided downstream thereof. The pressure type flow rate control device has excellent flow rate control characteristics, that is, flow rate control can be performed stably even if the primary side supply pressure greatly fluctuates. (for example, Patent Document 1).

As the control valve for flow rate control used in the pressure type flow rate control device, a piezoelectric element driven valve (hereinafter, sometimes referred to as a piezo valve) is used. The piezo valve is configured to open and close a diaphragm valve element by a piezo actuator, thus having a high responsivity. In the pressure type flow rate control device, the opening degree of the control valve, for example, is feedback controlled on the basis of an output of the pressure sensor for measuring an upstream pressure P1, making it possible to appropriately control the flow rate of the gas flowing downstream the restriction part.

In recent years, in the semiconductor manufacturing process, in order to form an insulating film such as a silicon nitride film (SiNₓ film) or a silicon oxide film (SiO₂ film), an HCDS (Si₂Cl₆: Hexachlorodisilane) gas is supplied by an ALD (Atomic Layer Deposition) process. The HCDS is a material that can be decomposed and reacted at a low temperature, and a low-temperature semiconductor manufacturing process at 450 to 600° C., for example, can be realized.

However, since the HCDS (boiling point: about 144° C.) is a liquid at room temperature, the liquid HCDS can be vaporized using a vaporization supply apparatus and then supplied into the process chambers as a gas. In Patent Document 2, the present applicant discloses a vaporization supply apparatus for appropriately performing vaporization supply of an organometallic gas such as tetraethyl orthosilicate (TEOS) or HCDS. According to this vaporization supply apparatus, the liquid raw material is pressure-fed to a vaporization chamber of the vaporization supply apparatus and heated by a heater. The vaporized raw material gas is supplied to a process chamber at a flow rate controlled by the pressure type flow rate control device provided downstream of the vaporization chamber.

### PRIOR-ART DOCUMENT

### Patent Literature

Patent Document 1: Japanese Patent No. 3546153
Patent Document 2: International Publication No. WO2019/021948
Patent Document 3: International Publication No. WO2013/179550

### SUMMARY OF INVENTION

### Problems to be Solved by Invention

In the deposition of the silicon nitride film by the ALD process, for example, the steps of supplying an HCDS gas, a purge gas, an ammonia gas, and a purge gas to the process chamber are repeated in sequence each for a short time, for example, from 1 second to 10 seconds. Thus, in the ALD process, a pulsed gas supply for a short time is required, in some cases, the pressure type flow rate control device using a restriction part and a pressure sensor as described above may be difficult to correspond to the ALD process. In addition, in the pulsed flow rate control, appropriate control of the supply amount (volume or amount of substance) of the gas supplied in one pulse has been desired.

Furthermore, the gas generated in the vaporization section of the vaporization supply apparatus, or a vaporizer may be supplied in a pulsed manner at a relatively large flow rate. In this case, since the flow rate is limited by the restriction part in the pressure type flow rate control device, sometimes it is difficult to flow the gas at a relatively large flow rate. In addition, in order to provide the organometallic gas or the HCDS gas as described above, it is necessary to keep the entire supply path at a high temperature (e.g., 200° C.) to prevent re-liquefaction, so it is desired that the flow rate can be measured even when the gas is at a high temperature.

Therefore, when supplying a high-temperature gas from the vaporizer, there is a problem with appropriately controlling a pulsed gas supply, particularly at a large flow rate. For this purpose, rather than performing flow rate measurement and flow rate control using an upstream pressure sensor provided between the control valve and the restriction part as in the conventional pressure type flow rate control device, it is advantageous to be able to measure the flow rate and the gas supply amount by other methods as simple as possible.

The present invention has been made to solve the above-mentioned problems, and its main object is to provide a method for measuring the supply amount of a gas supplied from a vaporizer and a gas supply amount control method using the same.

### Means for Solving Problem

The gas supply amount measurement method according to an embodiment of the present invention is performed in a gas supply system including a vaporization section, a control valve provided downstream of the vaporization section, and a supply pressure sensor for measuring a supply pressure between the vaporization section and the control valve, and includes the steps of: measuring an initial supply pressure using the supply pressure sensor in a state where the control valve is closed; opening the control valve for a predetermined period of time; measuring the supply pressure for a plurality of times between a time when a pressure starts to fall from the initial supply pressure and a time after a predetermined time has elapsed when the control valve is opened for the predetermined period of time; and calculating the gas supply amount when the control valve is opened for the predetermined period of time based on the plurality of measured values of the supply pressures.

In one embodiment, the step of obtaining the gas supply amount by calculation includes a step of calculating the gas supply amount by integrating the calculated flow rates based on the measured values of the supply pressures.

In one embodiment, the step of obtaining the gas supply amount by calculation includes a step of determining the gas supply amount ΣQ(tn)dt by the following equation based on an initial supply pressure P0i, a plurality of measured values P(tn) of supply pressures, in the following equation, Q(tn) is a flow rate at time tn, dt is an sampling period, Qi is an initial flow rate determined on the basis of the initial supply pressure P0i and the Cv value of the control valve, P0(tn) is a supply pressure at time tn.

ΣQ(tn)dt=ΣQi×(P0(tn)/P0i)dt

In one embodiment, when opening the control valve for a predetermined time, the control valve is opened to the maximum opening degree corresponding to the maximum set flow rate.

In one embodiment, the control valve is a piezoelectric valve.

In one embodiment, the gas vaporized in the vaporization section is Si₂Cl₆.

The gas supply amount control method according to an embodiment of the present invention includes a step of opening the control valve for a predetermined time by one pulse based on a pulsed flow rate control signal, a step of measuring the gas supply amount of one pulse by any one of the above measurement methods; a step of correcting the pulsed flow rate control signal based on the comparison result between the measured gas supply amount and the preset desired gas supply amount; and a step of opening the control valve for a predetermined time by one pulse based on the corrected pulsed flow rate control signal.

In one embodiment, the step of measuring the gas supply amount of one pulse is performed for the first pulse gas supply in the process of performing a plurality of pulsed gas supplies, when performing a subsequent pulsed gas supply, the corrected pulsed flow control signal is used.

### Effect of Invention

According to the gas supply amount measurement and the gas supply amount control method of the embodiments of the present invention, even when a relatively high-temperature gas generated in a vaporizer is supplied in a pulsed manner, the gas supply amount can be measured and controlled by a relatively simple method, and the method can be applied to gas supply at a relatively large flow rate.

### BRIEF DESCRIPTION OF DRAWINGS

FIG. 1 is a diagram exemplarily showing a gas supply system in which a gas supply amount measurement method according to an embodiment of the present invention is performed.

FIG. 2 is a diagram exemplarily showing a more specific gas supply system in which the gas supply amount measurement method according to the embodiment of the present invention is performed.

FIG. 3 is a graph showing a time change of the flow rate setting signal (opening and closing signal of the control valve) Sv and the supply pressure P0 in the vaporization chamber, when implementing the gas supply amount measurement method according to the embodiment of the present invention.

FIG. 4(a) is an enlarged graph showing a drop period of the supply pressure P0 in the graph of FIG. 3 and FIG. 4(b) shows the size (area) of the time-integrated P0.

FIG. 5 is an enlarged graph showing a recovery period of the supply pressure P0 in the graph of FIG. 3.

FIG. 6 shows an exemplary flow chart of the gas supply measurement method according to an embodiment of the present invention.

### DETAILED DESCRIPTION OF EMBODIMENT

Hereinafter, embodiments of the present invention will be described in detail with reference to the drawings. However, the present invention is not limited to the embodiments described below.

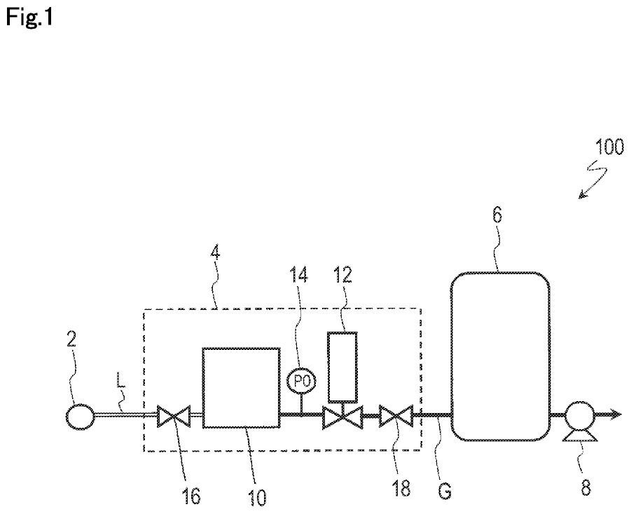

FIG. 1 shows an example of the gas supply system 100 in which the gas supply amount measurement method and the gas supply amount control method of the present embodiment are implemented. The gas supply system 100 is configured to vaporize a liquid raw material L in a vaporization supply apparatus 4 and supply the vaporized gas as a gas G to a process chamber 6. The liquid raw material L is pumped from a liquid raw material source 2 to the vaporization supply apparatus 4. A vacuum pump 8 is connected to the process chamber 6, and both the process chamber 6 and the flow paths connected to the process chamber 6 can be vacuumed. In FIG. 1, the liquid flow path is shown by a white line, and the gas flow path is shown by a thick line.

Examples of the liquid raw material source 2 include organometallics, such as TEOS (tetraethyl orthosilicate), TMGa (trimethylgallium), and TMAl, (trimethylaluminum), or HCDS (Si₂Cl₆). In the following embodiment, an example of vaporizing and supplying the HCDS will be described. The boiling point of the HCDS is about 144° C. and the vapor pressure is about 250 kPa at 190° C.

The vaporization supply apparatus 4 of the present embodiment includes a vaporization section (or a vaporizer) 10 and a control valve 12 provided downstream of the vaporization section 10. The vaporization section 10 is provided with a heater (not shown), and the liquid raw material L can be vaporized in the vaporization section 10. As the heater, a jacket heater or a heater in which a cartridge heater is buried in an aluminum plate as a heat transfer member (e.g., the heater described in Patent Document 2) may be used.

The vaporized raw material is supplied to the process chamber 6 at an arbitrary flow rate in accordance with the opening degree of the control valve 12. As the control valve 12, for example, it is possible to use a piezo valve configured to open and close the diaphragm valve element by a piezo actuator. The piezo valve is configured to be able to open to an arbitrary opening degree by controlling the driving voltage applied to the piezoelectric element.

In addition, the vaporization supply apparatus 4 of the present embodiment includes a liquid replenishment valve 16 provided upstream of the vaporization section 10, a stop valve 18 provided downstream of the control valve 12, and a supply pressure sensor 14 for measuring the gas pressure (supply pressure P0) in the vaporization section 10. As the liquid replenishment valve 16 and the stop valve 18, an AOV (air driven valve) or the like is preferably used. As the supply pressure sensor 14, a pressure sensor having high-temperature resistance is suitably used.

In the vaporization supply apparatus 4, it is possible to perform the gas supply in a manner by opening and closing of the control valve 12 or the stop valve 18 in a pulsed manner.

The supply amount of the liquid raw material to the vaporization section 10 can be controlled by adjusting the opening and closing intervals, or the open time periods of the liquid replenishment valve 16. Termination of the gas supply to the process chamber 6 can be reliably performed using the stop valve 18. A three-way valve may be provided between the stop valve 18 and the control valve 12, and if a three-way valve is used, the source gas and the purge gas may be switched to flow at a desired timing.

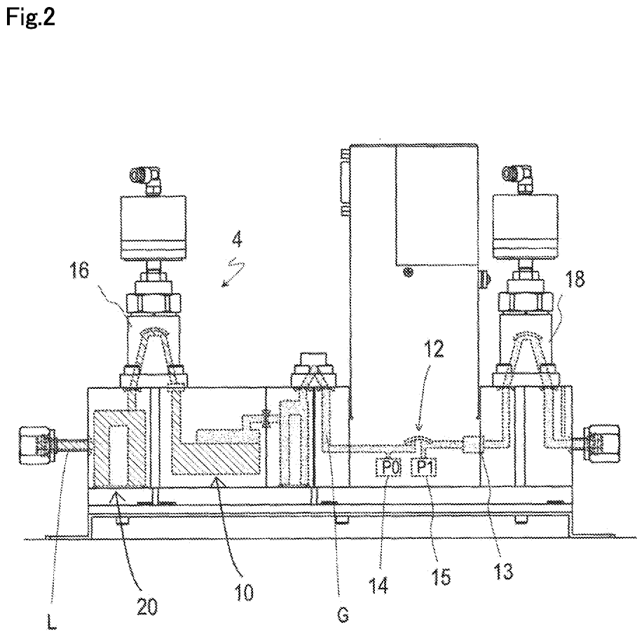

FIG. 2 shows a more specific configuration of the vaporization supply apparatus 4. The vaporization supply apparatus 4 shown in FIG. 2 has a preheating section 20 provided upstream of the vaporization section 10 and the liquid replenishment valve 16. The preheating section 20 is provided to assist the vaporization in the vaporization section 10, and by heating the liquid raw material in advance, it is possible to reduce the necessary amount of heat in the vaporization section 10, and to suppress the decrease in temperature at the time of vaporization due to latent heat of vaporization.

A heater (not shown) is provided respectively to the preheating section 20 and the vaporization section 10. In addition, another heater (not shown) is provided in the flow rate control section configured by the control valve 12. The preheating section 20, the vaporization section 10, and the flow rate control section, which is the flow path including the control valve 12, can be controlled to different temperatures respectively, and typically, the vaporizing section 10 is maintained at a higher temperature than the preheating section 20, and the flow rate control section is maintained at a higher temperature than the vaporization section 10 to prevent re-liquefaction. When vaporizing the HCDS, the heater of the vaporizing section 10 is set to a temperature of 180 to 200° C. for example.

In the vaporization supply apparatus 4 shown in FIG. 2, the downstream side of the control valve 12 is connected to the stop valve 18 via a gasket 13. This makes it easier to flow the gas at a higher flow rate than that in a pressure type flow rate control device having a restriction part at the same position. In addition, in the vaporization supply apparatus 4 shown in FIG. 2, although a downstream pressure sensor 15 for measuring the pressure P1 downstream of the control valve 12 is provided, when performing the gas supply amount measurement according to the measurement method of the present embodiment to be described later, the downstream pressure sensor 15 is not necessarily required. However, the gas supply amount measurement method of the present embodiment may also be implemented in a gas supply system for controlling the flow rate and the gas supply amount by the pressure type flow rate control device having a restriction part or the downstream pressure sensor 15.

As the vaporization supply apparatus 4, a vertical configuration disclosed in International Application No. PCT/JP2020/033395 by the present applicant may be adopted. In the vertical configuration, the preheating section, the vaporization section, and the flow rate control section are arranged superimposed in three vertical stages. In addition, in FIG. 2, even though the preheating section 20, the vaporization section 10, and the control valve 12 (or the flow rate control section) or the like are shown as an integrated configuration provided on a common base table, these components may be spaced from each other.

When eliminating the restriction part in order to flow gas at a larger flow rate as described above, the opening degree of the control valve 12 may be open-loop controlled based on the input flow rate setting signal. In addition, as described later, when performing the pulsed flow rate control, the opening and closing time of the control valve 12 may be adjusted on the basis of the measurement result of the gas supply amount of one pulse when the gas starts flowing. By correcting the control signal to the control valve 12 based on the measured flow rate, it is possible to perform the gas supply at a desired pulse flow rate (gas supply amount).

In the gas supply system 100 configured as described above, the gas supply amount downstream of the control valve 12 is measured. In the present embodiment, the gas supply amount is measured on the basis of the output of the supply pressure sensor 14 (i.e., the measurement results of the supply pressure P0) after opening the control valve 12 from closing. Hereinafter, a concrete description will be given.

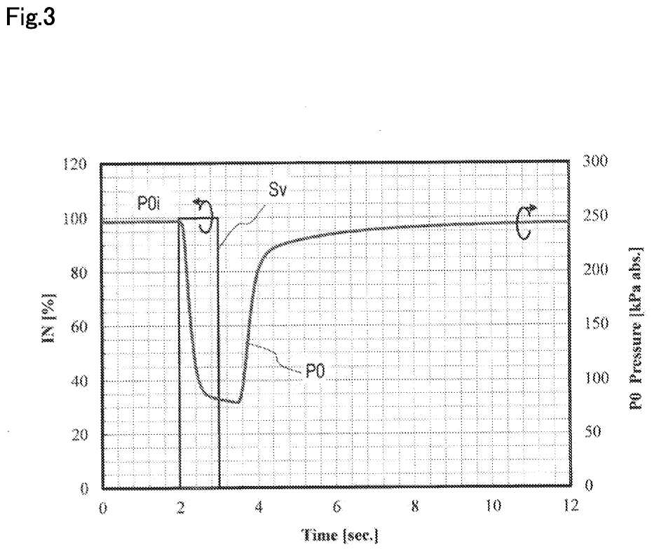

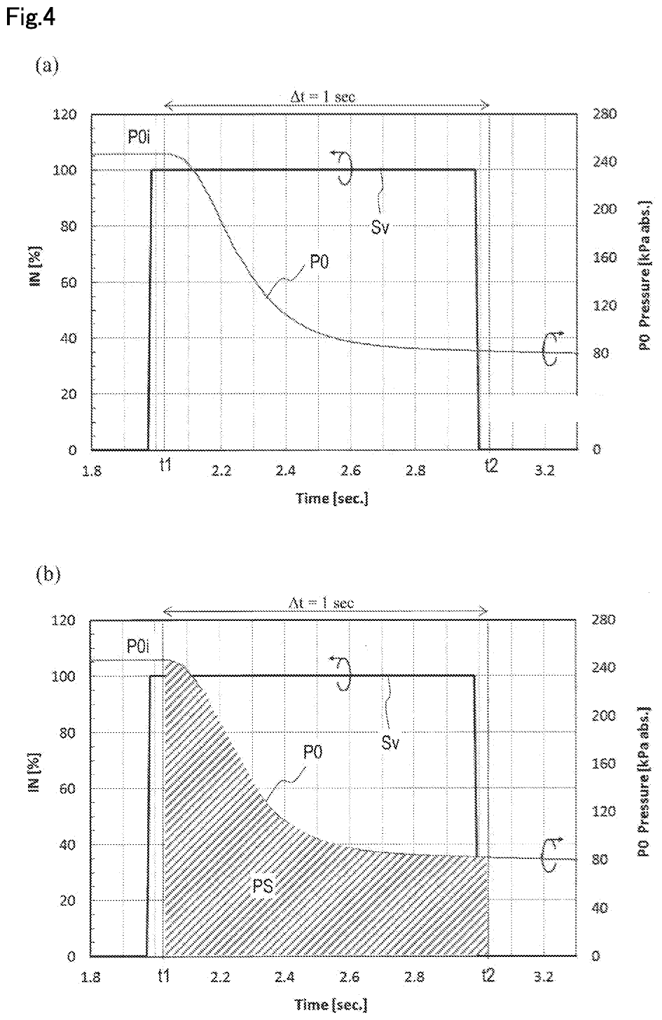

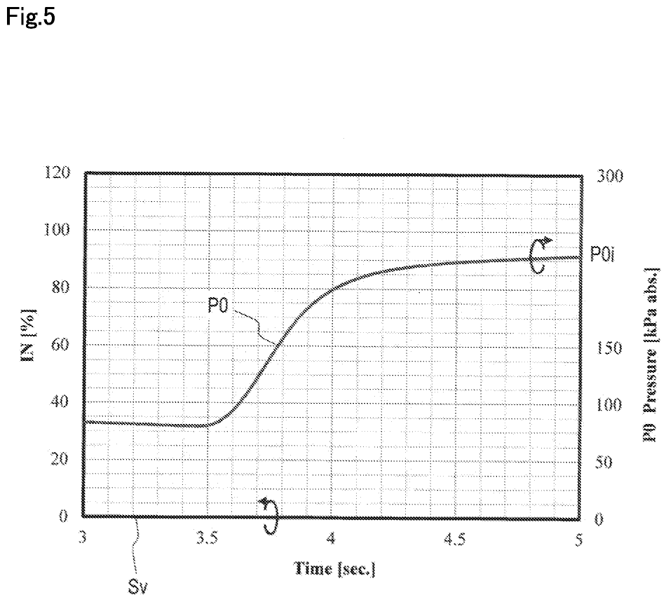

FIG. 3 shows the time change of the opening and closing signal (flow rate setting signal) Sv of the control valve 12 and the corresponding supply pressure P0. FIG. 4(a) and FIG. 4(b) are views enlarged along the time axis of the drop timing of the supply pressure P0 in FIG. 3, and FIG. 5 is a view enlarged along the time axis of the recovery timing of the supply pressure P0 in FIG. 3.

As shown in FIG. 3, FIG. 4(a) and FIG. 4(b), in the state before the gas supply amount measurement, the control valve 12 is closed, and the supply pressure P0 is maintained at the initial supply pressure P0i. The initial supply pressure P0i varies depending on the materials to be vaporized and the set heater temperature. For example, when the HCDS is maintained saturated at 190° C., it is maintained at about 250 kPa abs, which is the vapor pressure at that temperature.

In addition, during the measurement of the gas supply amount, the liquid replenishment valve 16 is maintained in the closed state, and the addition of the liquid raw material is not performed. On the other hand, the stop valve 18 is maintained in the open state, and the downstream side of the control valve 12 is typically maintained at a vacuum pressure (e.g., 100 Torr or less).

Next, as shown in FIGS. 3, 4(a), and 4(b), by opening the control value 12 for a predetermined time (here, one second), the gas, which was accumulated upstream of the control value 12, flows out downstream of the control value 12. At this time, in the present embodiment, the control valve 12 is opened to the maximum opening degree (opening degree corresponding to 100% flow rate setting (IN100%) in accordance with the flow rate setting signal Sv.

During the period when the control valve 12 is open, the supply pressure P0 measured by the supply pressure sensor 14 decreases with the outflow of gas. In the present embodiment, the falling supply pressure P0 is measured every predetermined sampling period (e.g., 10 msec), and the results are stored in a memory. Then, based on the measured supply pressure P0, the gas supply amount is obtained by the accumulation corresponding to a predetermined time Δt which is the opening time of the control valve. The gas supply amount corresponding to the one pulse (gas supply volume and gas supply mass) is in correspondence with the integrated value PS of the supply pressure P0 as shown in FIG. 4(b).

However, the period for calculating the integral gas supply amount is set to a period from time t1 at which the actual drop in the supply pressure P0 is confirmed to time t2 at which the predetermined time Δt has elapsed. This is because the actual opening and closing of the control valve 12 may occur slightly delayed from the valve control signal, more appropriate data can be obtained in a way to determine the integrated the gas supply amount during a predetermined period after confirming the actual pressure drop.

Hereinafter, a specific example of the method for measuring the gas supply amount for one pulse based on the measurement of the supply pressure P0 will be described.

First, the Cv value (coefficient of flow) when the control valve 12 is opened to the maximum opening degree is obtained in advance. The Cv value is a general indicator of the flow easiness of the fluid through the valve and corresponds to the flow rate of the gas flowing through the valve when the primary pressure and the secondary pressure of the valve are constant. Under the conditions of valve secondary pressure ≤valve primary pressure/2 (under critical expansion conditions), the gas flow rate Q (sccm) is given by the following equation (1) using the Cv value, for example. In the present embodiment, the valve primary pressure is the supply pressure P0 and the valve secondary pressure is the pressure P1 downstream of the valve.

Q=34500·Cv·P0/(Gg·T)^{1/2} (1)

In the above equation (1), Q is the flow rate (sccm), Gg is the specific gravity of the gas, P0 is the supply pressure, i.e., the primary pressure (kPa abs) of the valve, and T is the temperature (K). The specific gravity Gg of HCDS is about 9.336. As described above, under the condition when the supply pressure P0 is two times or more large than the downstream pressure P1, if the gas temperature T is constant, the flow rate Q is considered to be proportional to the supply pressure P0.

In addition, the Cv value can be represented by using the flow path cross sectional area A and the contraction coefficient (contraction flow ratio) α of the valve, here, if assuming the flow path cross sectional area A at the time when the piezo valve is opened to the maximum opening is A=πDL, using the sheet diameter D (e.g., about 6 mm) and the valve lift amount L (e.g., about 50 μm), the Cv value can be given by the following equation (2),

Cv=A·α/17=πDL·α/17 (2)

Therefore, if the Cv value of the valve is known, based on the above equation (1), it is possible to determine the flow rate Q based on the supply pressure P0. Note that the Cv value is not limited to the value obtained by the above equation (2), and may be obtained by other methods. For example, the Cv value can also be obtained on the basis of the measurement result of the supply pressure P0 when the gas flows at the measured flow rate Q, which is measured by a flow meter provided downstream of the valve.

Therefore, from the measurement result of the supply pressure P0, the flow rate Q(t) at each time is determined, and the gas supply amount in each micro time dt (here sampling period) is Q(t)·dt. For example, based on the measurement result of the initial supply pressure P0i, together with calculating the initial flow rate Qi using the Cv value of the valve from the above equation (1), multiplying the ratio of the measured pressure P0(t) with respect to the initial supply pressure P0i at time t with the initial flow rate Qi, that is, the flow rate Q(t) at each time, and the gas supply amount flowing between the micro time dt (such as volume and substance) Q(t)·dt can be determined according to Q(t)=Qi×(P0(t)/P0i).

Then, the gas supply amount in one pulse when the control valve 12 is opened for a predetermined time Δt can be expressed as ΣQ(tn)·dt=Q(t1)·dt+Q(t2)·dt++Q(tn)·dt, where the flow rate at the time tn (n is a natural number) of each sampling is Q(tn). In addition, it can be expressed by the following equation (3) when using the supply pressure P0 at time tn:

$$\sum Q ( tn ) \cdot dt = \sum Qi \times ( P 0 ( tn ) / P 0 i ) \cdot dt = ( Qi \cdot dt / P 0 i ) \times ( P 0 ( t 1 ) + P 0 ( t 2 ) + … + P 0 ( tn ) ) \qquad ( 3 )$$

Here, when the sampling period dt and the number of samples n are used, the predetermined time Δt can be expressed as Δt=n×dt. Therefore, it can be described as ΣQ(tn)·dt=(1/n)·(Q(t1)+Q(t2)+ . . . +Q(tn))·Δt. In this way, it is possible to determine the integrated gas supply amount corresponding to the determined time Δt based on the measurement of a large number of times (n times) of the supply pressure P0 over a predetermined time Δt. In addition, as can be seen from the above equations (1) and (3), Q(t1)+Q(t2)+ . . . +Q(tn) is the magnitude associated with the integrated value PS of the measured supply pressure P0.

When the predetermined time Δt is 1 second, the sampling period dt is set to 10 msec, for example, and the number n of samples at this time becomes 100. However, it is not limited thereto, and the sampling period dt and the number n of samples may be arbitrarily set. However, since the shorter the sampling period dt is, the more accurately the integrated gas supply amount can be obtained, the sampling period dt is preferably 50 msec or less (the number of samples is 20 or more), and more preferably 20 msec or less (the number of samples is 50 or more). However, if the number of samples is too large, the load of the arithmetic processing increases, and therefore, the sampling period dt is preferably not less than 5 msec, i.e., not more than 200 samples. Of course, depending on the magnitude of the predetermined time Δt, the value of the sampling period dt and the number n of samples may be appropriately set.

As described above, according to the gas supply amount measurement method of the present embodiment, the gas supply amount corresponding to one pulse supplied from the vaporization section 10 via the control valve 12 can be obtained from the measurement result of the supply pressure P0 over the predetermined time period Δt.

Although the aspect when the control valve 12 is opened to the maximum set opening degree for a predetermined period is described above, it is not limited thereto. The control valve 12 may be opened to an arbitrary opening degree that is not maximum. However, when obtaining the integrated gas supply amount as described above, it is preferable to obtain the Cv value corresponding to the arbitrary opening degree, for example, the Cv value at an opening degree can be obtained by changing the valve lift amount L in the above equation (2) to a value corresponding to the opening degree.

Patent Document 3 by the present applicant discloses a method of monitoring the flow rate in a build down manner by measuring the pressure (supply pressure P0) upstream of the control valve using an on-off valve provided upstream of the pressure type flow rate control device. However, it should be noted that the Patent Document 3 only discloses the method of performing the flow rate measurement while flowing a gas at a constant flow rate downstream of the pressure type flow rate control device after detecting only the initial decrease in the supply pressure P0, it does not disclose the method of measuring the gas supply amount corresponding to one pulse in the pulsed flow rate control.

After the gas supply of one pulse is completed as described above, the control valve 12 is closed following the flow rate setting signal Sv which changes to 0%. At this time, as shown in FIG. 3 and FIG. 5, the supply pressure P0 is recovered, and typically will return to the initial supply pressure P0i.

Recovery of the supply pressure P0 is started slightly delayed from the fall of the flow rate setting signal Sv, but this is because the control signal actually given to the control valve 12 includes a delay, the control valve 12 is considered to have not become a complete shut-off state for a while from the fall of the flow rate setting signal Sv. Normally, after the control valve 12 is actually closed, the supply pressure P0 begins to recover immediately.

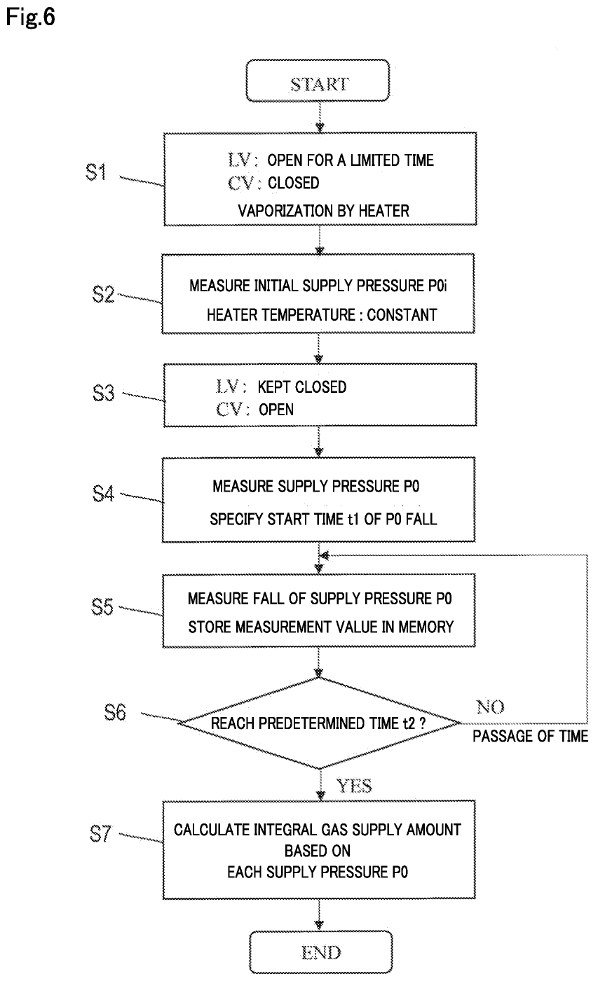

Hereinafter, a specific example of the gas supply amount measurement processing flow will be described. FIG. 6 shows a flow chart of the gas supply amount measurement. First, as shown in step S1, the liquid replenishment valve 16 (LV) is opened for only a predetermined time while the control valve 12 (CV) is closed. Thus, a predetermined amount of liquid raw material is supplied to the vaporization section. The supplied raw material is heated and vaporized by a heater.

Next, as shown in step S2, the initial supply pressure P0i is measured in a state where the heater temperature is maintained constant. When a sufficient liquid raw material is supplied to the vaporization section, a pressure corresponding to the species of the raw material and the heater temperature is detected. However, depending on the amount of the liquid raw material supplied to the vaporization section, a pressure lower than or equal to the vapor pressure may be detected.

Next, as shown in step S3, the control valve CV is opened while maintaining the closed state of the liquid replenishing valve LV. The control valve CV is now opened to the maximum opening. By opening the control valve CV, the gas flows downstream through the control valve at a flow rate based on the Cv value of the valve and the initial supply pressure P0i as described above.

Here, in step S4, the supply pressure P0 is measured and monitored to determine the time t1, at which the actual fall of the supply pressure P0 starts, that is, the time t1 at which the difference between the measured supply pressure P0 and the initial supply pressure P0i exceeds the threshold value. Then, the time t1 is set as the start time of P0 pressure fall. In addition, the time t2 at which a predetermined time Δt has elapsed from the time t1 is set as the predetermined time t2 indicating the end of the measurement.

Thereafter, as shown in steps S5 and S6, the value of the supply pressure P0 for each sampling cycle is stored in the memory during the period from the start time t1 until the predetermined time t2 (=t1+Δt) is reached. The measurement and recording of the supply pressure P0 are executed repeatedly until reaching the predetermined time t2.

Then, when the predetermined time t2 is reached, as shown in step S7, the integrated gas supply amount is determined by calculation from the measurement results of the supply pressure P0. As a result, the gas supply amount corresponding to one pulse is obtained. Incidentally, in the flowchart shown in FIG. 6, although the step of closing the control valve CV is not described, this step can be appropriately executed in parallel with the flow of obtaining the integrated gas supply amount when the predetermined time Δt has elapsed from the time of opening the control valve CV.

Although the gas supply amount measurement method according to the present embodiment has been described above, the control signal of the control valve 12 (CV) may be corrected based on the gas supply amount measured by the present method. Hereinafter, a concrete description will be given.

First, during the first one pulse gas supply at the beginning of the process, perform the opening and closing of the control valve 12 based on a predetermined pulse flow rate control signal (valve opening and closing command), and measure the gas supply amount of one pulse by the gas supply amount measurement method described above. Then, if the measured gas supply amount has a significant difference with respect to a desired set gas supply amount, correct the pulse flow rate control signal from the next one pulse gas supply, and control the opening and closing operation of the control valve 12.

For example, when the measured gas supply amount is larger than the predetermined desired amount, at least any one of the opening time period of the control valve 12 and the opening degree of the control valve 12 is set to a smaller value in accordance with the magnitude of the measured gas supply amount. As a result, the gas supply amount in the next one pulse gas supply can be reduced, and the gas supply can be performed in the desired amount.

On the other hand, when the measured gas supply amount is smaller than the desired amount, at least any one of the opening time period of the control valve 12 and the opening degree of the control valve 12 is set to a larger value. As a result, the gas supply amount in the next one pulse gas supply can be increased, and the gas supply can be performed in the desired amount.

Correction of the above valve opening and closing command is executed not only at the time of the first one pulse gas supply, but may be performed after the second time. This makes it possible to repeat the correction and perform the one pulse gas supply in the desired amount more reliably.

While the gas supply amount measurement method and the gas supply amount control method according to the embodiments of the present invention has been described above, various modifications can be made without departing from the spirit of the present invention.

### INDUSTRIAL APPLICABILITY

The gas supply amount measurement method and the gas supply amount control method according to the embodiments of the present invention are preferably used, for example, when performing pulsed flow rate control in a gas supply system.

### REFERENCE SIGNS LIST

2 Liquid raw material source
4 Vaporization supply apparatus
6 Process chamber
8 Vacuum pump
10 Vaporization section
12 Control valve
14 Supply pressure sensor
16 Liquid replenishment valve
18 Stop valve
20 Preheating section

1. A gas supply amount measurement method performed in a gas supply system including a vaporization section; a control valve provided downstream of the vaporization section; and a supply pressure sensor for measuring a supply pressure between the vaporization section and the control valve,
the gas supply amount measurement method comprising:
a step of measuring an initial supply pressure by the supply pressure sensor in a state where the control valve is closed;
a step of opening the control valve for a predetermined period of time;
a step of measuring a plurality of times of the supply pressure between a time at which a supply pressure starts to fall from the initial supply pressure and a time at which a predetermined time has elapsed, when the control valve is open for the predetermined period of time; and
a step of obtaining a gas supply amount when the control valve is open for the predetermined period of time by calculation based on a plurality of measurement values of the supply pressure.

2. The gas supply amount measurement method according to claim 1, wherein the step of obtaining the gas supply amount by calculation includes a step of calculating the gas supply amount by integrating the flow rate calculated on the basis of the measured value of the supply pressure.

3. The gas supply amount measurement method according to claim 1, wherein the step of obtaining the gas supply amount by calculation includes a step of obtaining the gas supply amount ΣQ(tn)·dt by the following equation based on the initial supply pressure P0i and the plurality of the measured values P0(tn) of the supply pressures, in the following equation, Q(tn) is a flow rate at time tn, dt is a sampling period, Qi is an initial flow rate determined on the basis of the initial supply pressure P0i and a Cv value of the control valve, P0(tn) is a supply pressure at time tn.
ΣQ(tn)·dt=ΣQi×(P0(tn)/P0i)·dt

4. The gas supply amount measurement method according to claim 1, wherein in the step of opening the control valve for the predetermined period of time, the control valve is opened to the maximum opening degree corresponding to the maximum set flow rate.

5. The gas supply amount measurement method according to claim 1, wherein the control valve is a piezoelectric valve.

6. The gas supply amount measurement method according to claim 1, wherein the gas vaporized in the vaporization section is Si₂Cl₆.

7. A gas supply control method performed by using the gas supply amount measurement method according to claim 1 including:
a step of opening the control valve for a predetermined period of time for one pulse based on a pulsed flow rate control signal;
a step of measuring the gas supply amount for one pulse by the gas supply amount measurement method according to claim 1;
a step of correcting the pulsed flow rate control signal based on a comparison result between the measured gas supply amount and a preset desired gas supply amount; and
a step of subsequently opening the control valve for the predetermined period of time for a next one pulse based on a corrected pulsed flow rate control signal.

8. The gas supply amount control method according to claim 7, wherein the step of measuring the gas supply amount for one pulse is performed for a first pulse gas supply in a process of performing the pulsed gas supply for a plurality of times, and when the pulsed gas supply is performed thereafter, the corrected pulsed flow rate control signal is used.
